(19) United States
(12) Patent Application Publication
(10) Pub. No.: US 2016/0048008 A1
(43) Pub. Date: Feb. 18, 2016

(54) Tracking-Free High Concentration Ratio Solar Concentrator

(71) Applicant: Yonghua Wang, Klamath Falls, OR (US)

(72) Inventor: Yonghua Wang, Klamath Falls, OR (US)

(21) Appl. No.: 14/121,241

(22) Filed: Aug. 14, 2014

(51) Int. Cl. G02B 19/00; G02B 5/10; G02B 5/04

(52) U.S. Cl. CPC G02B 19/0028; G02B 5/045; G02B 19/0042; G02B 5/10

(57) ABSTRACT

A stationary concentrator able to concentrator sunlight with high concentration ratio is consists of a Compound Parabolic Concentrator (CPC) and a prism array. A chamber with its thin transparent wall shaped into CPC and prism array is used to form a bulb-like close structure solar concentrator. Wherein, the non-image CPC with small acceptance half-angle is used to concentrate both beam light and diffuse light with high concentration ratio, and the prism array is used to refract the incident light to enlarge the acceptance angle of CPC, and therefore to realize stationary concentration. The bulb-like close structure concentrators are stacked together to realize arbitrary high concentration ratio of solar concentrator. The present concentrator structure enables the connection of truncated CPC to realize high concentration ratio and save the reflector areas. The stationary concentrator is able to concentrate both of beam light and diffuse light.

### TECHNICAL FIELD

The present disclosure relates generally to solar concentrators, more specifically, to tracking-free high concentration ratio solar concentrator.

### BACKGROUND

To enable the wide-spread adoption of solar energy and make solar energy the main stream of power supply, the substantially low cost and highly efficient solar concentrator system is the premise.

Solar energy is clean, abundant and ubiquitously distributed over the world. As the most desirable energy resource, solar energy brings in the hope for the future of the world as the fossil fuel is depleting. For solar energy to be a main stream power supply supporting power grid, building, and transportation systems, solar collection and conversion systems with ultra-high efficiency and substantial low cost must be created and developed. Relative to other energy resources, the major issues of solar energy that cause low efficiency and high cost of solar systems stem from the low energy current density of solar radiation and the motion of the sun. Average solar radiation intensity on earth is around 800 W/m², varying with location, weather and season. Due to the spin of the earth, the sun moves from east to west during a day. When the flat plate photovoltaic panel is installed to intercept the sunlight, the large area semiconductor devices are directly employed to collect and convert solar energy. This is one of the main reasons that cause high cost. In order to reduce the area of semiconductor converter, usually large area solar concentrator is used to condense solar radiation before the converter is used to convert it into electric power. The relative low cost of solar concentrator substantially reduces the cost of solar collector. However, under the current technology for high concentration ratio concentrator, any concentrating system must have tracking system that offsets the benefit of the solar concentrator. Therefore, tracking-free solar concentrator with high concentration ratio is the holy grail for high efficiency and low cost solar system.

U.S. Pat. No. 4,230,094 to Szulmayer disclosed an imaging system consisting of a Fresnel lens, a parabolic concentrator and a cylindrical receiver. Szulmayer's invention realized stationary concentration of solar energy with high concentration the first time in history. However, his system only works in a limited range of incident angle of light 30°. In his system, the Fresnel lens, parabolic concentrator and the cylindrical receiver have to be configured for the specially shaped receiver to be located in a special position to intercept the reflected light. Another drawback of his invention is that his concentrator can't concentrate diffuse light.

U.S. Pat. No. 6,717,045 to Chen disclosed a combined imaging and non-imaging system consisting of a Fresnel lens and a Compound Parabolic Concentrator (CPC). The Fresnel lens concentrates the intensity of sunlight to 5 times above normal level. Then the focused sunlight is further concentrated 20 times by the second optical concentrator CPC. Apparently, the system is unable to avoid tracking at all.

U.S. Pat. No. 3,923,381 to Winston disclosed non-imaging systems and devices for collection and concentration of electromagnetic energy and particularly solar energy. Winston's disclosure realizes the concentration of solar energy without substantial diurnal tracking. The concentrator of his invention is formed by compounding two parabolic concentrators to form a structure that enables the different reflective surface areas of the concentrator take turn to reflect incident sunlight to concentrate it. The concentrator is referred as Compound Parabolic Concentrator (CPC). The axes of the two parabolic concentrators form an angle called acceptance half-angle θ_{c}. The incidence light, no matter it is beam light or diffuse light, will be collected and concentrated to the exit aperture, as long as it falls into the acceptance half-angle. It means that as the sun is moving, the incident angle formed between the ray of incident sunlight and the axis of CPC is varying, but as long as the incident angle is smaller than the acceptance half-angle θ_{c}, the incident sunlight will be collected and concentrated. For a design of CPC with certain θ_{c}, the concentrator will operate in certain period of time during a day without tracking the sun. In principle, if θₑ is sufficient, the concentrator is able to concentrate sunlight during a whole day without tracking. Unfortunately, the concentration ratio of the concentrator is determined by θ_{c}. The larger the θ_{c}, the smaller the concentration ratio. For large θ_{c}, the concentration ratio is a small number. For instance, with θ_{c}=30°, the concentration ratio is 2 (refer to John Duffle & William Beckman, Solar Engineering of Thermal Processes, 3^{rd} Edition, 2006, pp 340-347). For concentration ratio only 10, θ_{c} must be as small as 6°. Ideally for day-long tracking-free concentration, the θ_{c} should be at least 75°. For practical application, the concentration ratio should be several hundreds and even more.

The objective of the present invention is to provide a non-image system or device that substantially enlarges the acceptance angle of CPC to avoid the diurnal tracking for concentration (e.g. realize stationary concentration) and in the mean time realizes large concentration ratio.

### SUMMARY

According to the present invention a tracking-free non-imaging system of concentration with high concentration ratio is provided for the collection and concentration of electromagnetic energy. Comprehended by the invention is a tandem structure with multiple stage concentration units stacked together to form a cascaded concentrating system. In which, each of the units includes a transparent cover of prism array and a CPC structure. The transparent cover of prism array and the CPC structure is configured in such a way that the CPC structure with small acceptance angle concentrates the incident light with a large concentration ratio and the prism array changes the direction of incident light to enforce the incident light falling into the acceptance half-angle of the CPC structure. In other words, the prism array enlarges the acceptance angle of the CPC concentrator. In one of the embodiments of this present invention, both the CPC structure and the prism array are shaped on the transparent wall of a bulb-like closed structure concentrator. When operates, the incident light impinging on the stationary apparatus in any direction will be refracted by the prism array first to fall in the acceptance half-angle of the CPC structure and get concentrated. Therefore, during the diurnal course of the motion of the sun, all the light in varying incident directions will be collected and concentrated. When the concentrating units are staked, and the incident light is concentrated in cascade, any high concentration ratio is able to be reached.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 shows the prior art a schematic drawing on construction of the CPC concentrator, which introduces some key concepts such as acceptance half-angle θ_{c}, focus of each of the parabolas, concentrator aperture, receiver, and axis of parabola.

FIG. 2 shows the prior art on the truncated CPC with the labels of the concentrator structure variables.

FIG. 3 is the schematic drawing illustrating the work principles of the present invention during the diurnal day.

FIG. 4 is the geometric diagram showing the refraction mechanism that changes the direction of the incident light on the prism.

FIG. 5 is the cross-sectional view of the first stage of the concentrator.

FIG. 6 is the over view of the first stage of the concentrator.

FIG. 7 is the cross-sectional view of the second stage of the concentrator.

FIG. 8 is the over view of the second stage of the concentrator.

FIG. 9 is the over view of the two stage concentrator.

FIG. 10 is the two dimensional version of the present invention.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

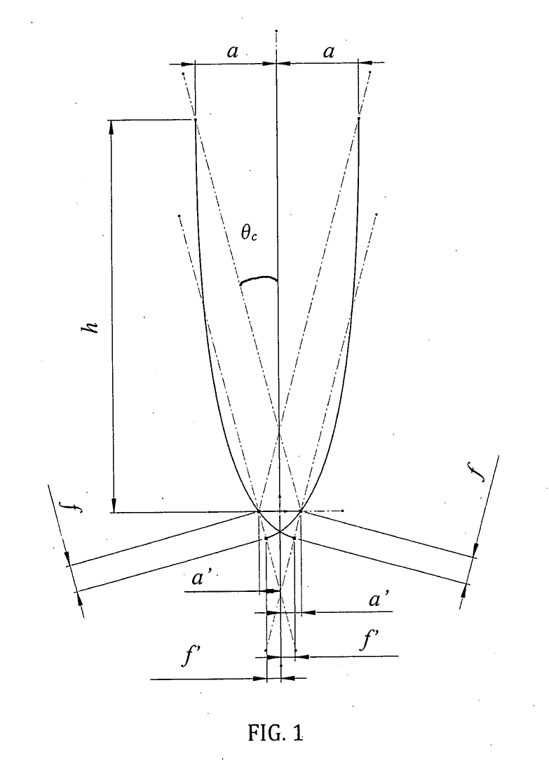

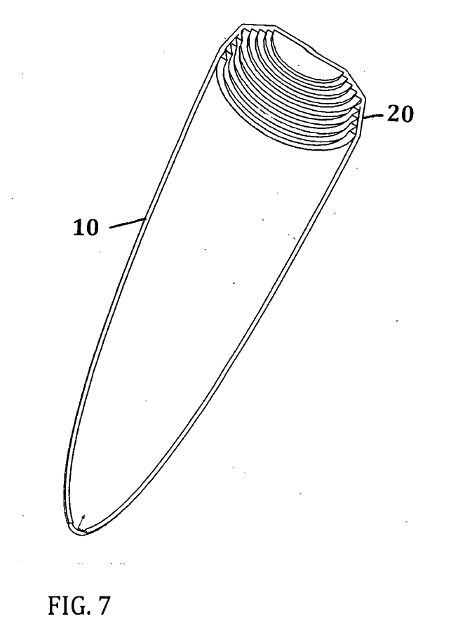

Referring to FIG. 1, the prior art of the basic concepts of CPC is illustrated in the reference (FIG. 7.6.1 of John Duffie & William Beckman, Solar Engineering of Thermal Processes, 4th Edition, 2013, pp 337-344). Each side of the CPC is a parabola; the focuses and axis of parabola are indicated. Each parabola extends until its surface is parallel with the CPC axis. The angle between the axis of the CPC and the line connecting the focus of one of the parabolas with opposite edge of the aperture is the acceptance half-angle θ_{c}. If the reflector is perfect, any radiation entering the aperture at angles between ±θ_{c} will be reflected to a receiver at the base of the concentrator by spectacularly reflecting parabolic reflectors.

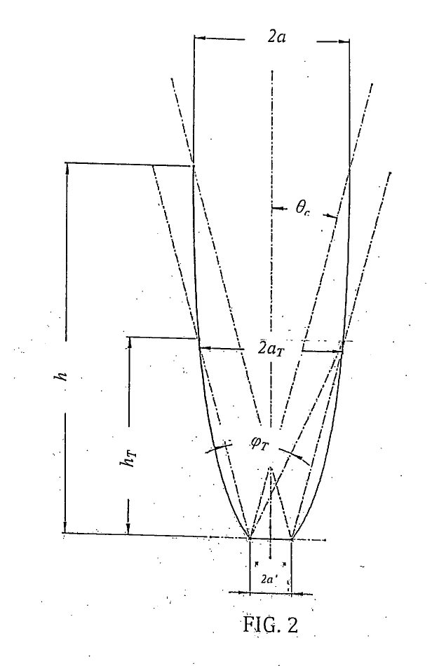

Referring to FIG. 2, the prior art of the CPC truncated to reduce its height from h to h′ with a resulting saving in reflector area but little sacrifice in performance. The truncated CPC is illustrated with the labels of structure variables.

$$f = {a}^{′} ( 1 + sin {θ}_{c} )$$

$$a = \frac{{a}^{′}}{sin {θ}_{c}}$$

$$h = \frac{f cos {θ}_{c}}{{sin}^{2} {θ}_{c}}$$

$${a}_{T} = \frac{f sin ( {φ}_{T} - {θ}_{c} )}{{sin}^{2} ( {φ}_{T} / 2 )} - {a}^{′} \\ {h}_{T} = \frac{f cos ( {φ}_{T} - {θ}_{c} )}{{sin}^{2} ( {φ}_{T} / 2 )} \\ C = \frac{{a}_{T}}{{a}^{′}}$$

As shown in the above formula (FIG. 7.6.3 of John Duffie & William Beckman, Solar Engineering of Thermal Processes, 4th Edition, 2013, pp 337-344), where a′ is the half-size of receiver, f is the focal lengthy of the elemental parabola for CPC, θ_{c} is acceptance half-angle, a is the half-size of aperture of the CPC, h is the height of CPC, a_{T} is the half-size of the aperture of truncated CPC, h_{T} is the height of truncated CPC, Φ_{T} is the truncation angle, C is concentration ratio, the concentration ratio is a function of the acceptance half-angles and truncation fraction. As plotted in FIG. 7.6.4, the smaller the acceptance half-angle, the larger the concentration ratio. The concentration ratio varies from 1 to 11, as the acceptance half-angle varies from 36° to 5°. For acceptance half-angle 6°, as the height-aperture ratio raises from 1 to 3, the concentration ratio changes from about 4.4 to 8.7. However, small acceptance half-angle means small aperture of concentrator and small time interval with no need for tracking.

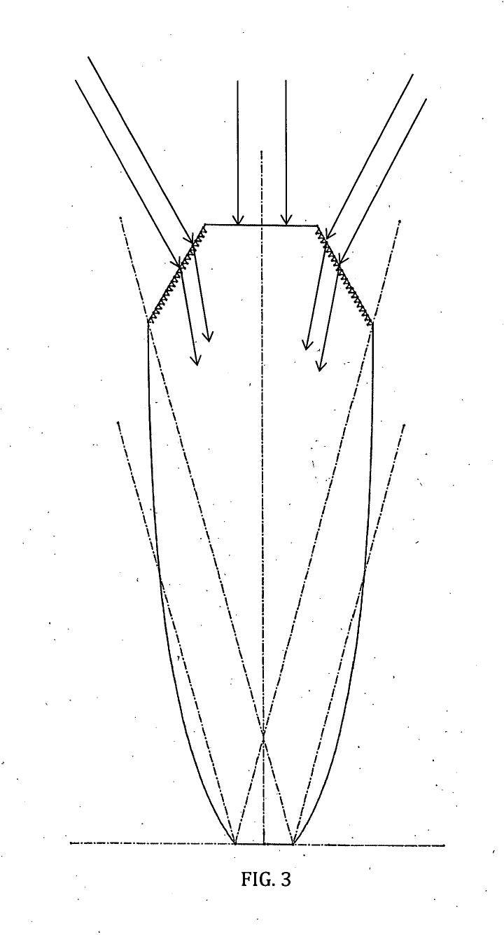

Referring to FIG. 3, in the present invention, a prism array 20 is added on the transparent cover of the conventional CPC 10 with small acceptance half-angle, so that the oblique incident light is refracted to fall in the small acceptance half-angle. During the diurnal day, the morning light is refracted by the left-hand side of the prism array, the afternoon light is refracted by the right-hand side of the prism array, and the noon light is affected little.

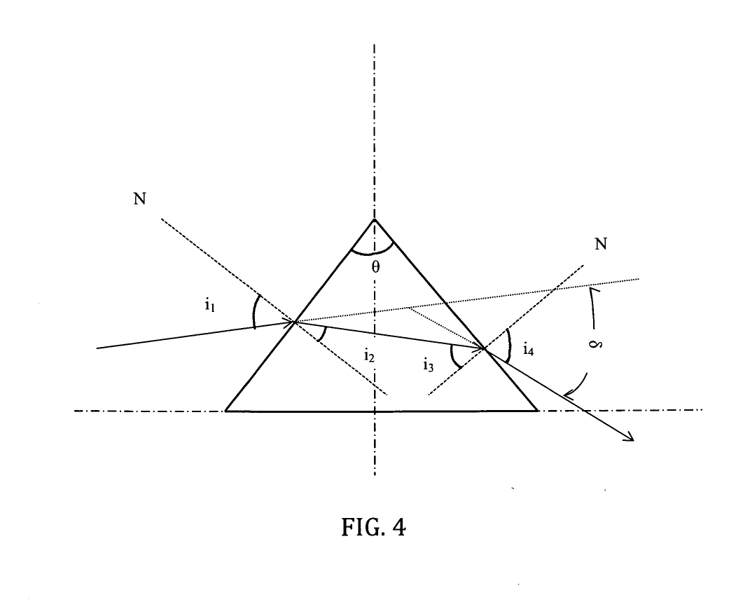

The prism optics is shown in FIG. 4, where i₁ is the incident angle on the first interface of prism, i₂ is the refraction angle of the first interface, i₃ and i₄ are incident angle and refraction angle of the second interface respectively, N is normal of interface, θ is prism apex angle, and δ is deviation angle. If a prism made with glass with index of refraction n=1.5 and with prism angle θ=60°, refracts the incident light with incident angle i₁=30°, the deviation angle is calculated to be δ=52.46°. Prism is able to significantly change the direction of the incident light. In the design of the prism array of the present concentrator, the prism apex angles of the prisms are positioned pointing to the axis of the CPC concentrator.

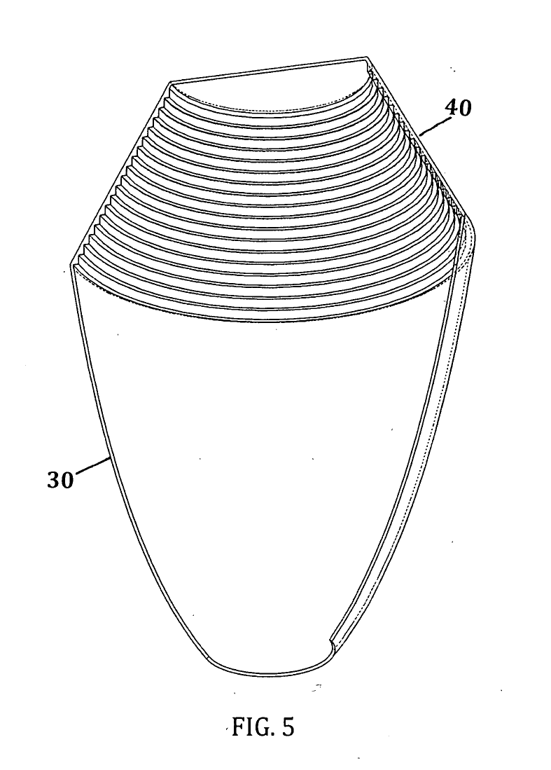

As shown in FIG. 5, the CPC concentrator 30 and the prism array 40 are shaped on transparent wall of a bulb-like chamber and form a close structure concentrator. FIG. 5 demonstrates the cross section structure of the concentrator.

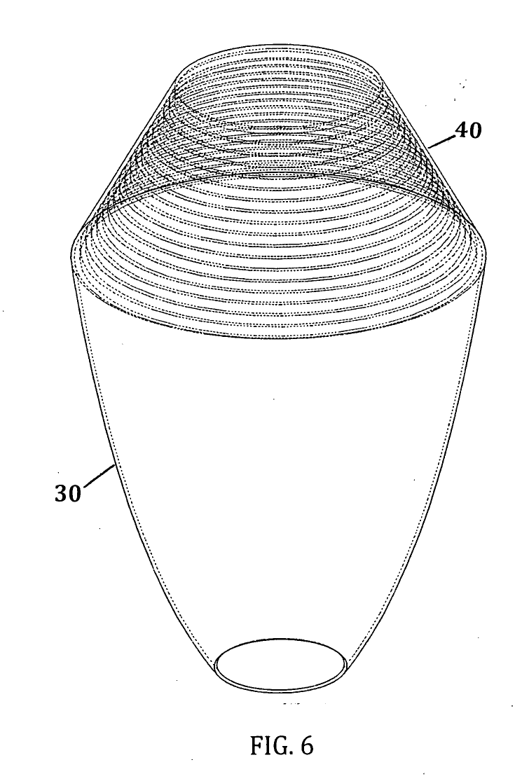

The overview of the first stage concentrator is shown in FIG. 6. In this design, the prism array 40 only has one stage. It could be designed into multistage.

In FIG. 7, the second stage concentrator made of CPC 10 with smaller acceptance half-angle and larger concentration ratio is demonstrated. In this design, the prism array 20 has two stages to accommodate the variation of the angles of the incident light.

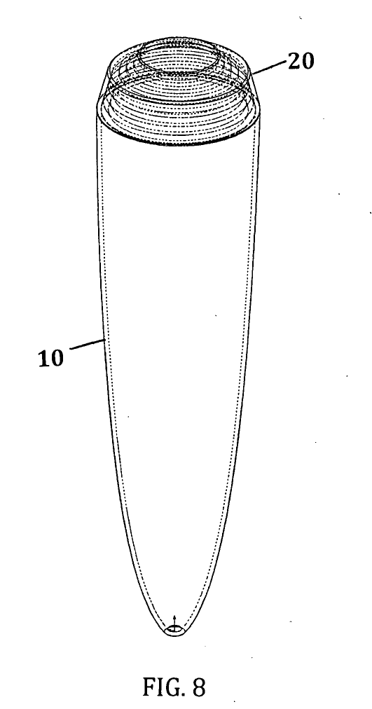

The overview of the second stage concentrator is shown in FIG. 8.

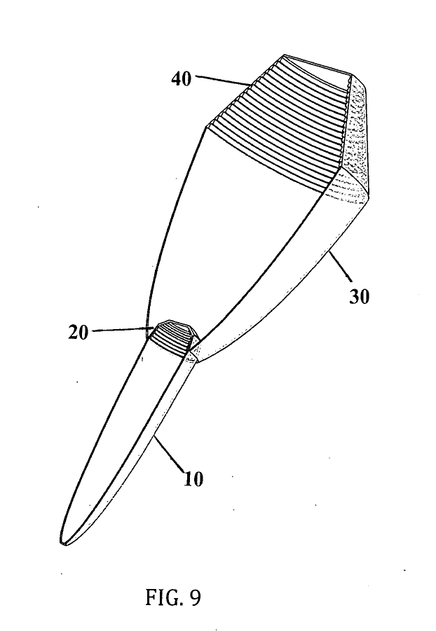

FIG. 9 shows the assembly of multiple concentrators to realize arbitrary high concentration ratio of stationary concentrator with broad acceptance angle. For instance, if the concentration ratio of the first stage concentrator is 64 and the concentration ratio of the second stage concentrator is 9, then the total concentration ratio of the stacked concentrator would be 576.

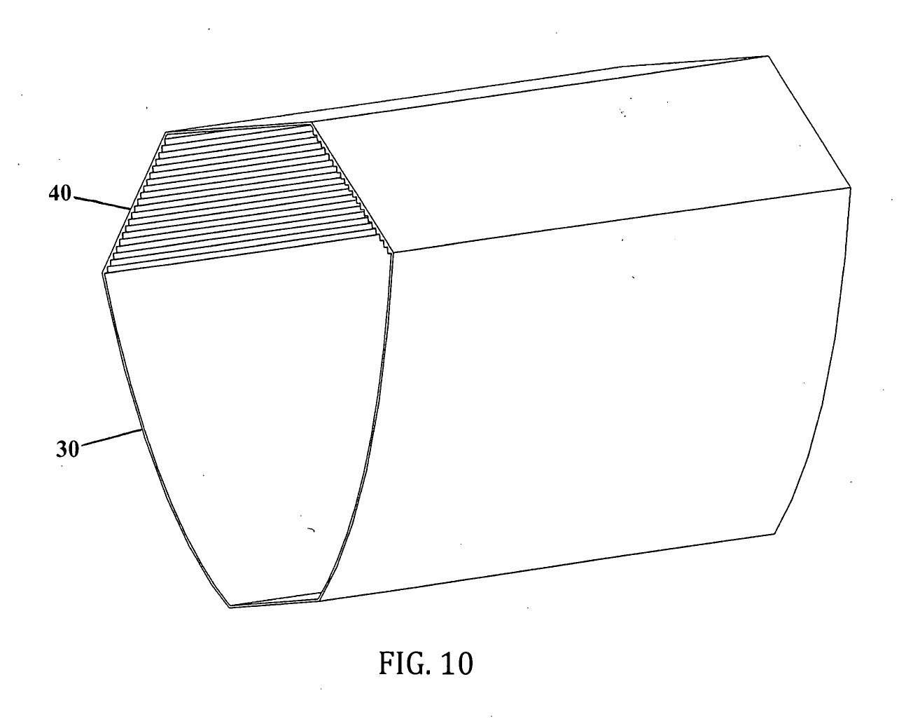

FIG. 10 shows the two dimensional version of the present invention the tube structure concentrator. Relative to the three dimensional version, the two dimensional version has relatively lower concentration ration but easy to be integrated into system.

The work principle of the concentrator structure is elucidated as the following. As the sun moving from morning to evening, the sunlight is refracted to change direction by various portion of the prism array surrounding the CPC so that the refracted sunlight falls into the relatively small acceptance half-angle of the CPC and is concentrated by it. The addition of the prism array to the CPC enlarges the acceptance angle of the CPC, and therefore enables the stationary concentration with high concentration ratio. Furthermore, the addition of the prism array to the lower stage CPC concentrator make it possible to accommodate the concentrated light by the upper stage CPC through refracting the light from the upper stage of CPC and therefore to realize cascading amplification of the incident sunlight. By stacking multiple stages of concentrator, the stationary concentrator assembly can easily realize arbitrary high concentration ratio.

From the description above, a number of advantages of the solar concentrator become evident. The stationary concentrator able to concentrate sunlight with high concentration ratio completely eliminates the need of tracking system and makes it possible to dramatically reduce the cost of solar system. Low cost concentrating system is not only able to promote the wide-spread adoption of solar system, but also able to upgrade the application of solar energy. For example, the concentrating system can be widely applied to middle and high temperature systems. The application of the present invention will extraordinarily reduce the cost of solar thermal power generation. The multistage CPC concentrator can not only realize arbitrary high concentration ratio, but also reduce the reflector area of CPC significantly by adopting truncated CPC. The present concentrator works for both beam light and diffuse light.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A solar concentrator, comprising a Compound Parabolic Concentrator (CPC) and a prism array with prisms arranged parallel or prism arrays connected in series; the prism array is mounted on the top of CPC along the edge of its top opening and forms certain angles with the top opening plane.
Wherein, the prism array or prism arrays change the direction of incident sunlight before it reach to the surface of the opening of CPC and make it fall in the acceptance half-angle of CPC any time during the diurnal day, so that sunlight incident to the opening of CPC with any angle will be collected and concentrated by the CPC.

2. The prism array or prism arrays of claim 1, wherein each of the prisms is arranged with its apex angle pointing up and toward the axis of CPC of claim 1 to reduce the incident angle of light relative to the axis of CPC of claim 1.

3. The CPC of claim 1 can be three dimensional.

4. The solar concentrator of claim 1 with the CPC of claim 2, wherein the prism array or prism arrays are circles surrounding the edge of the opening of the CPC of claim 2.

5. The CPC of claim 1 can be two dimensional.

6. The solar concentrator of claim 1 with the CPC of claim 4, wherein the prism arrays are mounted along the two edges of the CPC of claim 4.

7. The solar concentrator of claim 2 can be a transparent chamber with the lower portion of its thin wall shaped into CPC and the upper portion of its thin wall shaped into prism array or prism arrays.

8. The solar concentrator of claim 4 can be a transparent tube with the lower portion of its thin wall shaped into CPC and the upper portion of its thin wall shaped into prism array or prism arrays.

9. The solar concentrators of claim 6 as units are stacked to form multistage concentrator.

10. The solar concentrators of claim 7 as units are stacked to form multistage concentrator.
